(19) United States
(12) Patent Application Publication
(10) Pub. No.: US 2026/0100196 A1
(43) Pub. Date: Apr. 9, 2026

(54) HIERARCHICAL SPEECH ANALYSIS: A PROGRESSIVE APPROACH TO AGE, GENDER, AND EMOTION DETECTION

(71) Applicant: Tencent America LLC, Palo Alto, CA (US)

(72) Inventors: Hao ZHANG, Columbus, OH (US); Dong YU, Palo Alto, CA (US)

(73) Assignee: Tencent America LLC, Palo Alto, CA (US)

(21) Appl. No.: 18/905,436

(22) Filed: Oct. 3, 2024

(51) Int. Cl. G10L 25/63; G06N 3/045; G10L 25/24; G10L 25/30

(52) U.S. Cl. CPC G10L 25/63; G06N 3/045; G10L 25/24; G10L 25/30

(57) ABSTRACT

A method includes receiving a speech input signal of a speaker; preprocessing the speech signal to generate a preprocessed speech signal; detecting, via a first learning stage that receives the preprocessed speech signal, an initial age and an initial gender of the speaker; and determining, via a second learning stage that receives the initial age and the initial gender as inputs, a refined age of the speaker, a refined gender of the speaker, and an emotion of the speaker.

### FIELD

The disclosure generally relates to speech signal processing and machine learning for extracting and annotating information from speech data.

### BACKGROUND

Accurate annotation of speech data is critical for numerous applications, including voice assistants, emotion recognition systems, and personalized user experiences. Traditional methods for speech annotation have focused on individual tasks, such as transcription or speaker identification, often overlooking the rich paralinguistic and demographic information embedded in the speech signal. Recent advancements in deep learning have enabled more complex analyses, but existing methods typically handle tasks like age, gender, and emotion detection in isolation, lacking a unified approach. Moreover, existing deep learning approaches primarily concentrate on the direct prediction of target attributes, which can lead to suboptimal results, especially in the presence of incomplete label data.

Furthermore, the combination of speech characteristics, such as age and gender, can significantly influence the interpretation of emotional expressions. However, there has been limited exploration into the progressive integration of these features for more accurate emotion detection. Additionally, many datasets lack comprehensive labels. The challenge of incomplete labels arises from the fact that many available datasets do not simultaneously provide all the necessary labels for age, gender, and emotion. This issue complicates the training of models that require comprehensive label sets for effective learning. Additionally, the interaction between demographic factors (such as age and gender) and emotional expression is complex and often underexplored.

### SUMMARY

According to an aspect of the disclosure, a method performed by at least one processor includes receiving a speech input signal of a speaker; preprocessing the speech signal to generate a preprocessed speech signal; detecting, via a first learning stage that receives the preprocessed speech signal, an initial age and an initial gender of the speaker; and determining, via a second learning stage that receives the initial age and the initial gender as inputs, a refined age of the speaker, a refined gender of the speaker, and an emotion of the speaker.

According to an aspect of the disclosure, an apparatus includes: at least one memory configured to store program code; and at least one processor configured to read the program code and operate as instructed by the program code, the program code including: receiving coded configured to cause the at least one processor to receive a speech input signal of a speaker; preprocessing code configured to cause the at least one processor to preprocess the speech signal to generate a preprocessed speech signal; detecting code configured to cause the at least one processor to detect, via a first learning stage that receives the preprocessed speech signal, an initial age and an initial gender of the speaker; and determining code configured to cause the at least one processor to determine, via a second learning stage that receives the initial age and the initial gender as inputs, a refined age of the speaker, a refined gender of the speaker, and an emotion of the speaker.

According to an aspect of the disclosure, a non-transitory computer readable medium having instructions stored therein, which method performed by at least one processor, the method including: receiving a speech input signal of a speaker; preprocessing the speech signal to generate a preprocessed speech signal; detecting, via a first learning stage that receives the preprocessed speech signal, an initial age and an initial gender of the speaker; and determining, via a second learning stage that receives the initial age and the initial gender as inputs, a refined age of the speaker, a refined gender of the speaker, and an emotion of the speaker.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1.

FIG. 3 is an illustration of an example two-stage process, according to embodiments.

FIG. 4 is an illustration of an example Conditional Layer Normalization Transformer module flowchart of a self-consistency calibration process, according to embodiments.

FIG. 5 is a flowchart of an example process for determining an age, gender, and emotion of a speaker, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

The embodiments relate to the field of speech signal processing and machine learning, specifically to methods and systems for extracting and annotating information from speech data. The embodiments provide a multi-task learning framework for the joint detection of age, gender, and emotion from speech signals, leveraging both traditional audio features and deep learning embeddings. The extracted annotations can be used for various speech-related tasks and the development of large-scale speech models. The embodiments of the present disclosure addresses the gaps in conventional systems by introducing a progressive multi-task learning approach that integrates demographic embeddings with emotion detection, leveraging a hierarchical structure for refined predictions.

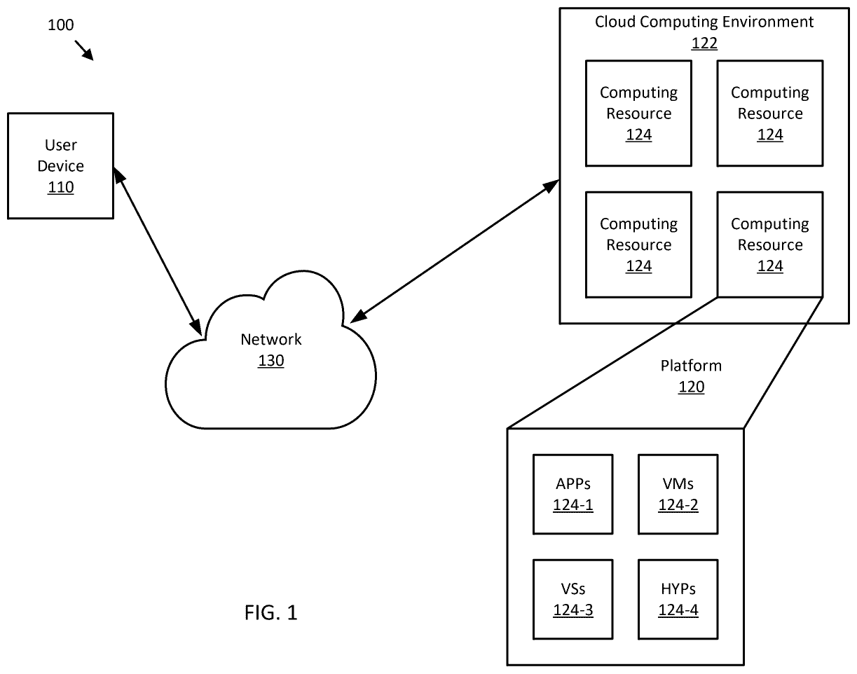

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSS) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

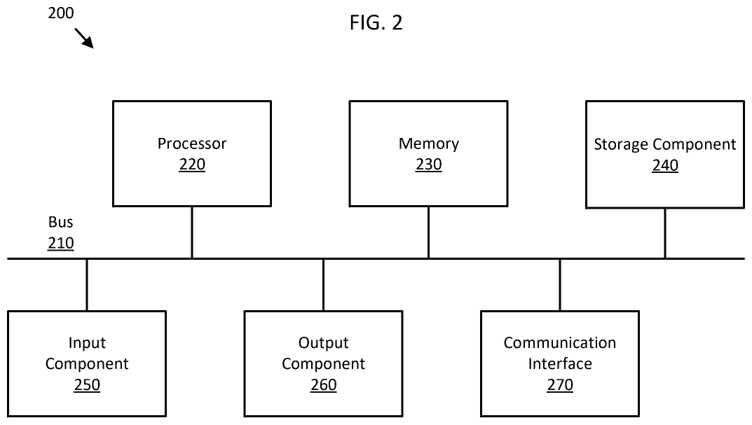

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

Embodiments of the present disclosure are directed to a method for hierarchical and progressive speech analysis, specifically targeting the joint detection of age, gender, and emotion. In one or more examples, the system is designed to estimate these attributes in a two-stage process.

In one or more examples, a first stage of the two-stage process includes an initial estimation stage. The method may begin with the extraction of traditional audio features, such as Mel-frequency cepstral coefficients (MFCCs) and Short-time Fourier transforms (STFTs). In one or more examples, a dedicated module, pre-trained on datasets labeled with age and gender, provides initial estimates and embeddings for these attributes. These demographic embeddings may serve as conditional inputs for the next stage.

In one or more examples, a second stage of the two-stage process includes a refined estimation stage. The second stage may involve a transformer model with Conditional Layer Normalization (CLN), which integrates the demographic embeddings with Wav2Vec embeddings through a cross-attention mechanism. This stage provides refined predictions for emotion and rectified estimates for age and gender. The multi-task learning framework allows the model to leverage shared representations and improve the robustness of the predictions.

In one or more examples, the training process may employ a combined loss function, incorporating both the initial and refined predictions. This loss function may ensure that the model learns from both stages and can make accurate predictions despite incomplete labels. A selective training strategy may be used to manage datasets with varying label completeness, ensuring effective model training across all available data.

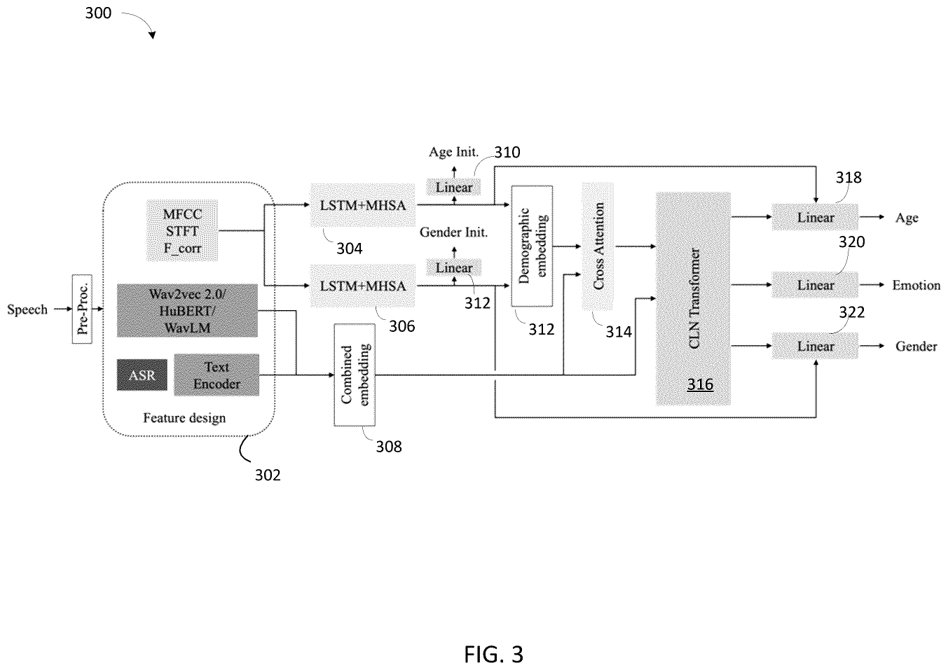

FIG. 3 illustrates an example system 300 for implementing the two-stage process. As shown in FIG. 3, the method involves a progressive multi-task learning approach that first estimates age and gender embeddings using traditional audio features and simple neural networks. These embeddings are then utilized as conditional inputs for a second-stage emotion detection, which also includes rectified predictions for age and gender.

In one or more examples, the detection task may be trained using speech signals from different datasets. Pre-processing steps may be applied to ensure consistency and improve the overall training process. In one or more examples, pre-processing may include normalization, energy equalization, silence removal, and resampling before sending the signals for model training. Through this procedure, the variability of training signals may be reduced, allowing the model to focus on the essential features relevant to the task. This preparation can lead to more robust and generalizable models, especially in multi-task and multi-dataset scenarios.

In one or more examples, a feature extraction module 302 may extract various features from the input speech signal, including MFCCs, STFTs, Frequency correlation (F_corr), Wav2Vec 2.0 embeddings, and text embeddings from an automatic speech recognition (ASR) system. These features capture both the acoustic and linguistic characteristics of the speech.

In one or more examples, the initial estimation stage may include a neural network architecture featuring a Long short-term memory network (LSTM) followed by a Multi-Head Self-Attention (MHSA) mechanism. As illustrated in FIG. 3, the system 300 includes LSTM+MHSA 304 for estimating an age and LSTM+MHSA 306 for estimating a gender. Both the LSTM+MHSA 304 and LSTM+MHSA 306 may be pre-trained on datasets labeled with age and gender. These modules may take MFCC, STFT, and F_corr features as inputs. The input features may be fused through a fully connected layer, which combines them into a unified representation. This representation is then processed by the LSTM network, followed by the MHSA mechanism. The final predictions for age and gender are obtained from subsequent linear layers 310 and 312. In addition to these initial predictions, the hidden state from the MHSA may be extracted as the corresponding embedding for age and gender. These embeddings serve as conditional information and additional inputs for the next stage of the system, enhancing the model's capability to refine subsequent predictions.

In one or more examples, the primary embeddings (Wav2Vec and text) may be combined 308 with demographic embeddings 312 using a cross-attention mechanism 314, where the demographic embeddings are obtained by passing the concatenation of age and gender embeddings through a fully connected layer. This step helps in integrating contextual demographic information with the primary speech features, enhancing the understanding of the speaker's characteristics and potential emotional states.

In one or more examples, the Conditional Layer Normalization (CLN) Transformer module 316 plays an important role for joint age, gender, and emotion detection from speech signals. This module is responsible for integrating demographic embeddings (derived from initial age and gender predictions) with the main speech embeddings, facilitating nuanced and accurate predictions for multiple tasks. The CLN Transformer 316 leverages the architecture of Transformer networks while incorporating conditional information through the innovative use of CLN. This structured flow ensures that the model effectively leverages both the content of the speech and the demographic context, allowing for accurate and personalized multi-task predictions. The inclusion of positional encoding before the MHSA ensures that the model maintains awareness of the order of the input sequence, which is crucial for temporal data like speech. The output of the CLN Transformer 316 is provided to linear layers 318, 320, and 322 for detecting age, emotion, and gender, respectively.

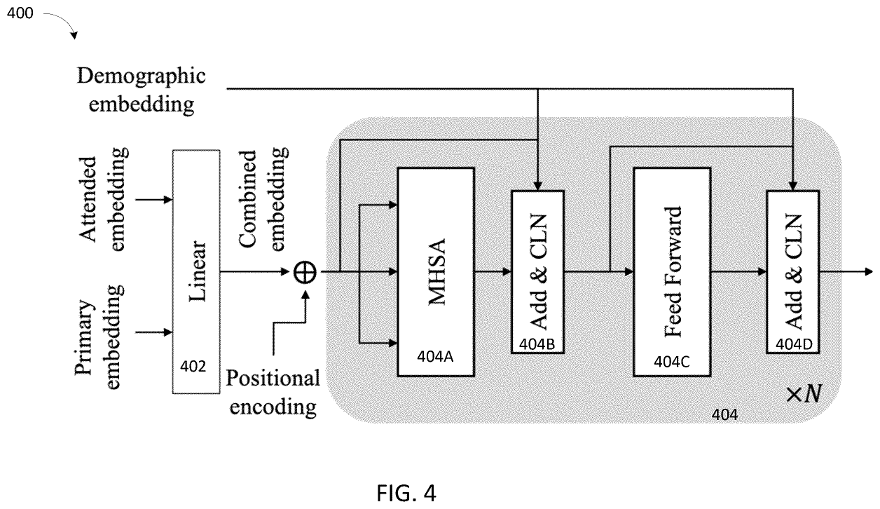

FIG. 4 illustrates an example configuration 400 of a CLN Transformer.

In one or more examples, positional encodings are added to the combined embeddings to provide information about the sequence order. The combined embeddings may be generated by passing primary embeddings and attended embeddings through linear layer 0402. Adding the positional encoding to the combined embeddings plays an important role because the CLN transformer may lack inherent sequential awareness. The positional encodings enable the model to understand the temporal structure of the input data, crucial for processing sequential information in speech.

The CLN transformer 404 may include a MHSA 404A, a first Add & CLN 404B, a feed forward network (FFN) 404C, and a second Add & CLN 404D. The CLN transformer 404 may be repeated N different times.

In one or more examples, the embeddings, now enriched with positional information, are passed through the MHSA mechanism 404A. The MHSA mechanism 404A allows the model to attend to different parts of the input sequence, capturing relationships and dependencies between different time steps. The attention mechanism may calculate a set of attention scores and uses them to produce weighted sums of the input representations, effectively focusing on the most relevant parts of the input.

In one or more examples, the output from the MHSA 404A is added to its input through residual connection and then passed through the Add & CLN layer 404B. In the Add & CLN layer 404B, normalization may be conditioned on the demographic embeddings, meaning the scale and shift parameters of the normalization process are dynamically adjusted based on the age and gender information. This conditioning enables the model to modulate its internal representations based on demographic context, helping to refine predictions for different groups.

In one or more examples, the normalized output from the Add & CLN layer 404B is further processed by a position-wise FFN 404C. The FFN 404C may include two linear transformations separated by a ReLU activation function. This component serves to transform the attended and normalized embeddings into a more suitable representation for the final prediction tasks. The output of the of the FFN 404C may be provided to the Add & CLN 404D.

According to one or more examples, the outputs of the CLN Transformer are used to provide final estimates for emotion, rectified age, and rectified gender. These outputs may be obtained through separate linear layers, which map the high-dimensional embeddings to the required output space. Skip-connections from the original feature extraction module to the final detection heads ensure that the model retains relevant information from the input features.

In one or more examples, the training process uses a combined loss function that includes cross-entropy (CE) terms for both the initial and refined predictions. This approach ensures that the model benefits from the hierarchical structure, progressively improving its predictions.

In one or more examples, given the issue of incomplete labels across different datasets, the selective training strategy selectively updates the model's parameters based on the available labels for each training instance. This approach allows the model to learn from datasets with varying label completeness, ensuring robust performance.

In one or more examples, each of the components illustrated in FIGS. 3 and 4 may be implemented by the computer system 200 (FIG. 2).

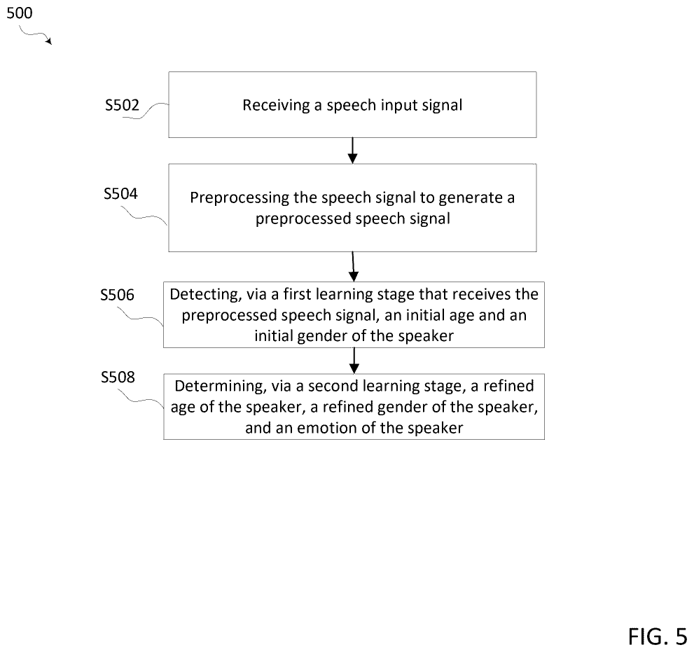

FIG. 5 is a flowchart of an example process 500 for determining an age, gender, and emotion of a speaker, according to embodiments. In one or more examples, the process 500 may be implemented by the processor 220 (FIG. 2).

The process 500 may start at operation S502 where a speech input signal is received. The speech input signal may be provided by a speaker.

The process proceeds to operation S504 where the speech signal is preprocessed to generate a preprocessed speech signal. The speech signal may be preprocessed by the feature extraction module 302.

The process proceeds to operation S506 where an initial age and initial gender of a speaker are detected via a first learning stage. In one or more example, the first learning stage may include LSTM+MHSA 304 for estimating an age and LSTM+MHSA 306 for estimating a gender.

The process proceeds to operation S508 where a refined age of the speaker, a refined gender of the speaker, and an emotion of the speaker are determined via a second learning stage. In one or more examples, the second learning stage is may include the CLN Transformer module 404.

Embodiments of the present disclosure may be used separately or combined in any order. Further, each of the embodiments (and methods thereof) may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method performed by at least one processor, the method comprising:
receiving a speech input signal of a speaker;
preprocessing the speech signal to generate a preprocessed speech signal;
detecting, via a first learning stage that receives the preprocessed speech signal, an initial age and an initial gender of the speaker; and
determining, via a second learning stage that receives the initial age and the initial gender as inputs, a refined age of the speaker, a refined gender of the speaker, and an emotion of the speaker.

2. The method according to claim 1, wherein the preprocessing the speech signal further comprises:
extracting audio features from the speech input signal including at least one of Mel-frequency cepstral coefficients (MFCC), Short-time Fourier Transform coefficients, Wav2Vec embeddings, and text embeddings from an automatic speech recognition system.

3. The method according to claim 1, wherein the preprocessing the speech signal further comprises:
performing, on the speech input signal, at least one of normalization, energy equalization, silence removal, and resampling.

4. The method according to claim 1, wherein the detecting, via the first learning stage, the initial age and the initial gender comprises:
inputting the preprocessed speech signal into a first neural network architecture to detect the initial age, wherein the first neural network architecture comprises a long short-term memory network (LSTM) followed by a Multi-Head Self-Attention (MHSA) mechanism; and
inputting the preprocessed speech signal into a second neural network architecture to detect the initial gender, wherein the second neural network architecture comprises a LSTM followed by a MHSA.

5. The method according to claim 4, further comprising:
inputting the initial age, the initial gender, and one or more features extracted from the preprocessed speech signal into a cross-attention mechanism; and
inputting an output of the cross-attention mechanism into the second learning stage.

6. The method according to claim 1, wherein the determining, via the second learning stage, the refined age of the speaker, the refined gender of the speaker, and the emotion, further comprises:
inputting the initial age and the initial gender into a Conditional Layer Normalization CLN)Transformer module.

7. The method according to claim 6, wherein the CLN transformer module comprises:
a Multi-Head Self-Attention (MHSA) mechanism that receives the initial age, the initial gender, and position encoding information indicating a sequence order of data input into the MHSA;
a first Add and CLN layer that receives an output of the MHSA;
a feed-forward network (FFN) that receives and output of the first Add and CLN layer, wherein the FFN comprises two linear transformations separated by a rectified linear unit (ReLU); and
a second Add and CLN layer that receives an output of the FFN.

8. An apparatus comprising:
at least one memory configured to store program code; and
at least one processor configured to read the program code and operate as instructed by the program code, the program code including:
receiving coded configured to cause the at least one processor to receive a speech input signal of a speaker;
preprocessing code configured to cause the at least one processor to preprocess the speech signal to generate a preprocessed speech signal;
detecting code configured to cause the at least one processor to detect, via a first learning stage that receives the preprocessed speech signal, an initial age and an initial gender of the speaker; and
determining code configured to cause the at least one processor to determine, via a second learning stage that receives the initial age and the initial gender as inputs, a refined age of the speaker, a refined gender of the speaker, and an emotion of the speaker.

9. The apparatus according to claim 8, wherein the preprocessing code further comprises:
extracting code configured to cause the at least one processor to extract audio features from the speech input signal including at least one of Mel-frequency cepstral coefficients (MFCC), Short-time Fourier Transform coefficients, Wav2Vec embeddings, and text embeddings from an automatic speech recognition system.

10. The apparatus according to claim 8, wherein the preprocessing code further comprises:
performing code configured to cause the at least one processor to perform, on the speech input signal, at least one of normalization, energy equalization, silence removal, and resampling.

11. The apparatus according to claim 8, wherein the detecting code further comprises:
first neural network code configured to cause the at least one processor to input the preprocessed speech signal into a first neural network architecture to detect the initial age, wherein the first neural network architecture comprises a long short-term memory network (LSTM) followed by a Multi-Head Self-Attention (MHSA) mechanism; and
second neural network code configured to cause the at least one processor to input the preprocessed speech signal into a second neural network architecture to detect the initial gender, wherein the second neural network architecture comprises a LSTM followed by a MHSA.

12. The apparatus according to claim 11, wherein the program code further comprises:
cross-attention code configured to cause the at least one processor to input the initial age, the initial gender, and one or more features extracted from the preprocessed speech signal into a cross-attention mechanism, wherein the determining code is further configured to cause the at least one processor to input an output of the cross-attention mechanism into the second learning stage.

13. The apparatus according to claim 8, wherein the determining code further comprises:
Conditional Layer Normalization (CLN) code configured to cause the at least one processor to input the initial age and the initial gender into a Conditional Layer Normalization CLN) Transformer module.

14. The apparatus according to claim 13, wherein the CLN transformer module comprises:
a Multi-Head Self-Attention (MHSA) mechanism that receives the initial age, the initial gender, and position encoding information indicating a sequence order of data input into the MHSA;
a first Add and CLN layer that receives an output of the MHSA;
a feed-forward network (FFN) that receives and output of the first Add and CLN layer, wherein the FFN comprises two linear transformations separated by a rectified linear unit (ReLU); and
a second Add and CLN layer that receives an output of the FFN.

15. A non-transitory computer readable medium having instructions stored therein, which method performed by at least one processor, the method comprising:
receiving a speech input signal of a speaker;
preprocessing the speech signal to generate a preprocessed speech signal;
detecting, via a first learning stage that receives the preprocessed speech signal, an initial age and an initial gender of the speaker; and
determining, via a second learning stage that receives the initial age and the initial gender as inputs, a refined age of the speaker, a refined gender of the speaker, and an emotion of the speaker.

16. The non-transitory computer readable medium according to claim 15, wherein the preprocessing the speech signal further comprises:
extracting audio features from the speech input signal including at least one of Mel-frequency cepstral coefficients (MFCC), Short-time Fourier Transform coefficients, Wav2Vec embeddings, and text embeddings from an automatic speech recognition system.

17. The non-transitory computer readable medium according to claim 15, wherein the preprocessing the speech signal further comprises:
performing, on the speech input signal, at least one of normalization, energy equalization, silence removal, and resampling.

18. The non-transitory computer readable medium according to claim 15, wherein the detecting, via the first learning stage, the initial age and the initial gender comprises:
inputting the preprocessed speech signal into a first neural network architecture to detect the initial age, wherein the first neural network architecture comprises a long short-term memory network (LSTM) followed by a Multi-Head Self-Attention (MHSA) mechanism; and
inputting the preprocessed speech signal into a second neural network architecture to detect the initial gender, wherein the second neural network architecture comprises a LSTM followed by a MHSA.

19. The non-transitory computer readable medium according to claim 18, further comprising:
inputting the initial age, the initial gender, and one or more features extracted from the preprocessed speech signal into a cross-attention mechanism; and
inputting an output of the cross-attention mechanism into the second learning stage.

20. The non-transitory computer readable medium according to claim 15, wherein the determining, via the second learning stage, the refined age of the speaker, the refined gender of the speaker, and the emotion, further comprises:
inputting the initial age and the initial gender into a Conditional Layer Normalization CLN)Transformer module.
